(19) United States
(12) Patent Application Publication
(10) Pub. No.: US 2023/0280827 A1
(43) Pub. Date: Sep. 7, 2023

(54) DETECTING USER-TO-OBJECT CONTACTS USING PHYSIOLOGICAL DATA

(71) Applicant: APPLE INC., Cupertino, CA (US)

(72) Inventors: Sterling R. CRISPIN, Santa Cruz, CA (US); Dimitri E. DIAKOPOULOS, San Jose, CA (US); Grant H. MULLIKEN, Los Gatos, CA (US); Izzet B. YILDIZ, Sunnyvale, CA (US)

(21) Appl. No.: 18/113,649

(22) Filed: Feb. 24, 2023

Related U.S. Application Data
(63) Continuation of application No. PCT/US2021/046588, filed on Aug. 19, 2021.
(60) Provisional application No. 63/071,406, filed on Aug. 28, 2020.

(51) Int. Cl. G06F 3/01

(52) U.S. Cl. CPC G06F 3/015; G06F 3/017

(57) ABSTRACT

Some implementations disclosed herein provide systems, methods, and devices that predict or otherwise determined aspects of a user-to-object contact using physiological data, e.g., from eye tracking or an electromyography (EMG) sensor. Such a determination of user-to-object contact may be used for numerous purposes.

### CROSS-REFERENCE TO RELATED APPLICATIONS

This patent application is a continuation of International Application No. PCT/US2021/046588 filed on Aug. 19, 2021, which claims the benefit of U.S. Provisional Application No. 63/071,406 filed on Aug. 28, 2020, entitled “DETECTING USER-TO-OBJECT CONTACTS USING PHYSIOLOGICAL DATA,” each of which is incorporated herein by this reference in its entirety.

### TECHNICAL FIELD

The present disclosure generally relates to providing improved user experiences on electronic devices, and in particular, to systems, methods, and devices that detect user-to-object contacts.

### BACKGROUND

Existing computer-based techniques make various determinations about user activities based on images, e.g., images of a user's hand and his or her surrounding physical environment. For example, various techniques are used to identify pointing, waving, and other hand gestures using images of a user's hands. Techniques for detecting user-to-object contacts based on image data may not be as accurate as desired. For example, such techniques may not provide sufficient accuracy with respect to identifying whether a user's finger is touching an object or hovering slightly above the object. As another example, such techniques may not provide sufficient accuracy with respect to precisely identifying the time at which a touch between a user and an object occurs.

### SUMMARY

Some implementations disclosed herein provide systems, methods, and devices that predict or otherwise determine aspects of a user-to-object contact using physiological data, e.g., based on eye tracking data and/or data from an electromyography (EMG) sensor. Such a determination of user-to-object contact may be used for numerous purposes. For example, such a determination of user-to-object contact may be used to identify input provided to an electronic device. In another example, such determination is used to determine user interactions with tables, walls, and other objects in a physical environment. In another example, such determination of user-to-object contact may be used to determine user interactions with physical objects in an extended reality (XR) environment. In some implementations, physiological data is used to supplement the image data used in a hand tracking process. For example, a hand tracking algorithm may track hand position and determine hand-to-object contacts based on image or depth data of the user's hand and the object. In this example, hand-to-object contacts determined by the hand tracking algorithm may be based upon and/or confirmed using physiological data.

In some implementations, an electronic device having a processor implements a method. The method obtains, via a sensor, physiological data of a user during a period of time while the user is using the electronic device. As examples, this may involve obtaining images of the eye, electrooculography (EOG) data measuring corneo-retinal standing potential from which gaze direction/movement can be determined, and/or electromyography (EMG) data measuring muscle-generated signals. The period of time may be a fixed window of time, e.g., 100 ms, 200 ms, 300 ms, 400 ms, 500 ms, etc.

Using the physiological data, the method determines a characteristic of an eye or muscle of the user during the period of time. In some implementations, the characteristic relates to gaze direction, gaze speed, gaze direction changes, pupil radius, pupil dilation, and/or pupil constriction. In some implementations, an inward facing camera on a head-mounted device (HMD) captures images of the user's eye and one or more eye characteristics are determined via a computer vision technique. In some implementations, the characteristic relates to muscle state based on electromyography (EMG) data. In some implementations, the characteristic is a combination of multiple user characteristics, e.g., both eye and muscle characteristics.

Using the characteristic of the eye or muscle of the user, the method determines a user-to-object contact. In some implementations, given physiological data for a period of time, e.g., a 300 ms time window, the method determines whether the time segment of the physiological data is immediately before a touch event or not, e.g., given data for a time segment from time −300 ms to time 0, whether there will be a touch event at time 0. In some implementations, given physiological data for the period of time, the method predicts whether there will be a touch event within a future time period or not, e.g., given data for a time segment from time −300 ms to time 0 whether there will be a touch event between time 0 and time 300 ms. In some implementations, given physiological data for a period of time, e.g., a 300 ms time window, the method predicts when a touch event will occur. In some implementations, a classifier or other machine learning model is used to perform the prediction.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining physiological data from a user during a user-to-object contact according to some implementations.

FIG. 2 illustrates a device obtaining physiological data from a user during a user-to-object contact according to some implementations.

FIG. 3 illustrates a device obtaining physiological data from a user during a user-to-object contact according to some implementations.

FIG. 4 illustrates a pupil of the user of FIGS. 1-3 in which the diameter of the pupil varies.

FIG. 5 is a flow chart illustrating an exemplary method of predicting a user-to-object contact using physiological data.

FIG. 6 illustrates exemplary physiological data associated with a user-to-object contact.

FIG. 7 illustrates time segments associated with a user-to-object contact.

FIG. 8 illustrates exemplary positioning of electrode pairs on a user's wrist.

FIG. 9 is a block diagram illustrating device components of an exemplary device according to some implementations.

FIG. 10 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

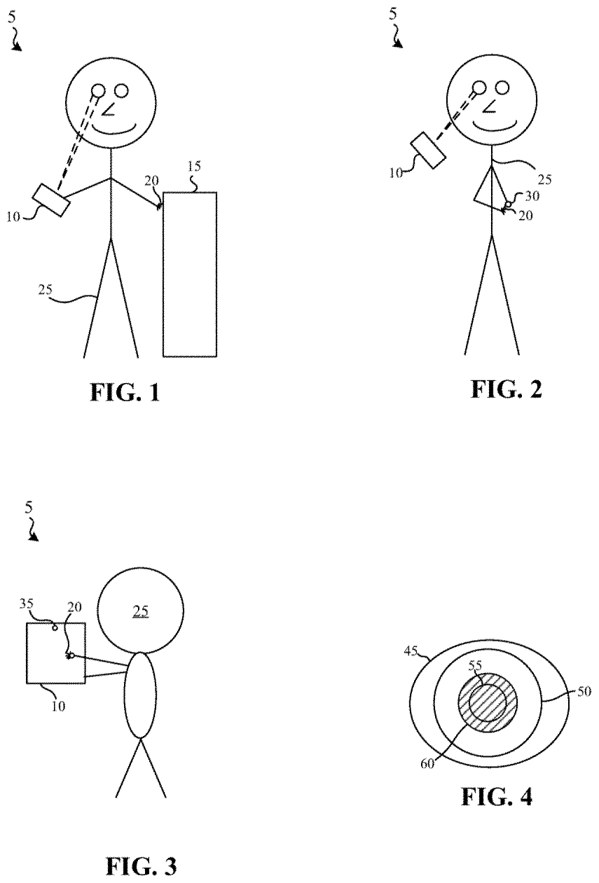

FIG. 1 illustrates a physical environment 5 including a device 10 configured to obtain physiological data (e.g., eye data, muscle data, etc.) from the user 25 via a sensor on device 10. The device may implement one or more of the techniques disclosed herein to obtain the physiological data, determine a user characteristic based on the physiological data, and determine a user-to-object contact based on the user characteristic. In FIG. 1, the user 25 uses the device 10 while interacting with one or more objects in the physical environment. Sensors on the device are configured to capture physiological data (e.g., based on the sensor capturing images of the user, contacting the skin of the user, etc.). During use of the device 10, the user touches finger 20 to object 15. Physiological data obtained by the sensor of device 10 is used to predict or otherwise determine aspects of such user-to-object contact, e.g., predicting that the contact will occur within predetermined time period or estimating when such contact will occur.

FIG. 2 illustrates another example of the device 10 obtaining physiological data from the user 25 during a user-to-object contact. In this example, during use of the device 10, the user touches finger 20 on one hand to the palm 30 of his or her other hand. In this example, user's own palm is the object that the user touches and that touch detected. Physiological data obtained by the sensor of device 10 is used to predict or otherwise determine aspects of the user-to-object contact with his or her palm 30, e.g., predicting that the contact will occur within predetermined time period or estimating when such contact will occur.

FIG. 3 illustrates another example of the device 10 obtaining physiological data from the user 25 during a user-to-object contact. In this example, during use of the device 10, the user touches finger 20 to a touch screen portion 20 of the device 10 itself. Physiological data obtained by the sensor 35 of device 10 (e.g., gaze direction, gaze speed, etc. determined based on image data of the user's eye) is used to predict or otherwise determine aspects of the user-to-object contact with device 10, e.g., predicting that the contact will occur within predetermined time period or estimating when such contact will occur.

In the examples of FIGS. 1-3, the user-to-touch contact may be determined based on physiological data and additional information. For example, a hand tracking algorithm may utilize images light intensity and/or depth sensor images (e.g., of the user's hand 10 and the object 15/palm 30/device 10) captured by a camera of device 10. Image-based hand tracking and physiological data-based contact detection may be combined to provide more robust and accurate user-to-object contact tracking than using the techniques independently of one another.

While the device 10 is illustrated in FIGS. 1-3 as a mobile device, other implementations involve devices of other types. In some implementations, as illustrated in FIGS. 1 and 3, the device 10 is a handheld electronic device (e.g., a smartphone or a tablet). In some implementations the device 10 is a laptop computer or a desktop computer. In some implementations, the device 10 has a touchpad and, in some implementations, the device 10 has a touch-sensitive display (also known as a “touch screen” or “touch screen display”). In some implementations, the device 10 is a wearable device such as a head mounted device (HMD), watch, armband, bracelet, necklace, anklet, or ring.

Moreover, while these examples and other examples discussed herein illustrate a single device 10 in a physical environment 5, the techniques disclosed herein are applicable to multiple devices as well as to multiple real world environments. For example, the functions of device 10 may be performed by multiple devices.

In some implementations, the device 10 includes an eye tracking system for detecting eye position and eye movements. For example, an eye tracking system may include one or more infrared (IR) light-emitting diodes (LEDs), an eye tracking camera (e.g., near-IR (NIR) camera), and an illumination source (e.g., an MR light source) that emits light (e.g., NIR light) towards the eyes of the user 25. Moreover, the illumination source of the device 10 may emit NIR light to illuminate the eyes of the user 25 and the NIR camera may capture images of the eyes of the user 25. In some implementations, images captured by the eye tracking system may be analyzed to detect position and movements of the eyes of the user 25, or to detect other information about the eyes such as pupil dilation or pupil diameter. Moreover, the point of gaze estimated from the eye tracking images may enable gaze-based interaction with content.

In some implementations, the device 10 has a graphical user interface (GUI), one or more processors, memory and one or more modules, programs or sets of instructions stored in the memory for performing multiple functions. In some implementations, the user 25 interacts with the GUI through finger contacts and gestures on the touch-sensitive surface. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 10 employs various physiological sensor, detection, or measurement systems. Detected physiological data may include, but is not limited to, electroencephalography (EEG), electrocardiography (ECG), electromyography (EMG), functional near infrared spectroscopy signal (fNIRS), blood pressure, skin conductance, or pupillary response. Moreover, the device 10 may simultaneously detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, one or both eyes of the user 25, including one or both pupils of the user present physiological data in the form of a pupillary response. The pupillary response of the user 25 results in a varying of the size or diameter of the pupil, via the optic and oculomotor cranial nerve. For example, the pupillary response may include a constriction response (miosis), e.g., a narrowing of the pupil, or a dilation response (mydriasis), e.g., a widening of the pupil. In some implementations, the device 10 may detect patterns of physiological data representing a time-varying pupil diameter.

FIG. 4 illustrates a pupil 50 of the eye 45 of the user 25 of FIGS. 1-3 in which the diameter of the pupil 50 varies with time. As shown in FIG. 4, a present physiological state (e.g., present pupil diameter 55) may vary in contrast to a past physiological state (e.g., past pupil diameter 60). For example, the present physiological state may include a present pupil diameter and a past physiological state may include a past pupil diameter. The physiological data may represent a response pattern that dynamically varies over time.

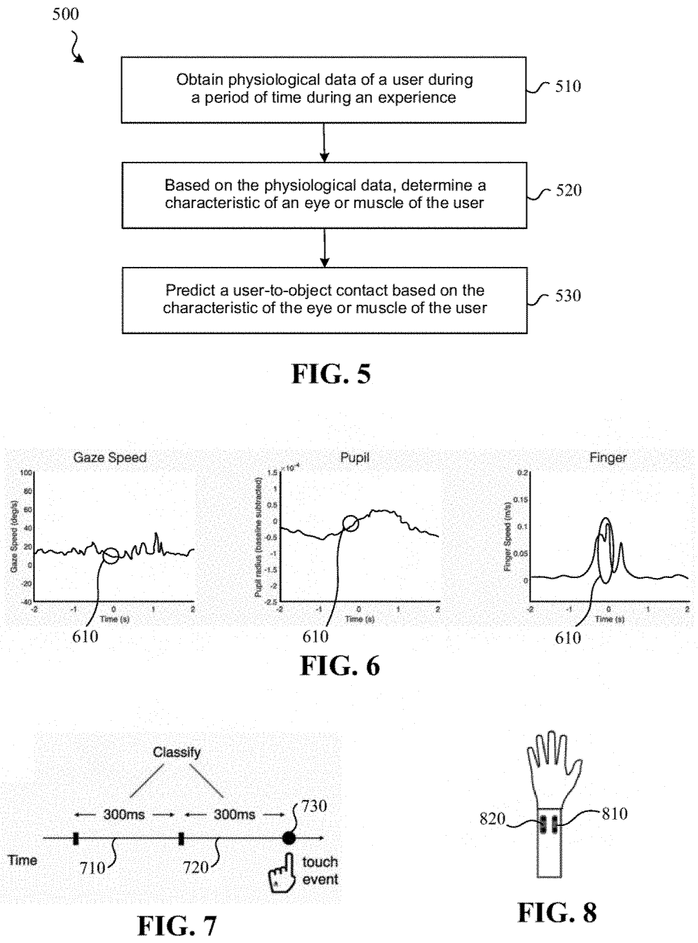

FIG. 5, in accordance with some implementations, is a flowchart representation of a method 500 for predicting or otherwise determining aspects of a user-to-object contact using physiological data. In some implementations, the method 500 is performed by one or more devices (e.g., device 10). The method 500 can be performed at a mobile device, HMD, desktop, laptop, or server device. In some implementations, the method 500 is performed by processing logic, including hardware, firmware, software, or a combination thereof. In some implementations, the method 500 is performed by a processor executing code stored in a non-transitory computer-readable medium (e.g., a memory).

At block 510, the method 500 obtains physiological data of a user during a period of time while the user is using the electronic device. As examples, this may involve obtaining images of the eye, electrooculography (EOG) data measuring corneo-retinal standing potential from which gaze direction/movement can be determined, and/or electromyography (EMG) data measuring muscle-generated signals. The period of time may be a fixed window of time, e.g., 100 ms, 200 ms, 300 ms, 400 ms, 500 ms, etc.

At block 520, based on the physiological data, the method 500 determines a characteristic of an eye or muscle of the user during the period of time. In some implementations, the characteristic relates to gaze direction, gaze speed, gaze direction changes, pupil radius, pupil dilation, and/or pupil constriction. In some implementations, an inward facing camera on a head-mounted device (HMD) captures images of the user's eye and one or more eye characteristics are determined via a computer vision technique. In some implementations, the characteristic relates to muscle state based on electromyography (EMG) data. In some implementations, the characteristic is a combination of multiple user characteristics, e.g., both eye and muscle characteristics.

At block 530, based on the characteristic of the eye or muscle of the user, the method 500 determines a user-to-object contact. One or more eye characteristics may be indicative of a user-to-object contact. For example, during a time period leading up to a user-to-object contact, the gaze of a user may stabilize and this stabilization may be an eye characteristic determined based on the physiological data. In some implementations, determining the user-to-object contact involves (a) predicting whether the period of time is immediately prior to the user-to-object contact, (b) whether the user-to-object contact will occur within a second period of time following the period of time, and/or (c) a time at which the user-to-object contact will occur.

As illustrated in FIG. 6, during a time period 610 leading up to a user-to-object contact (at time 0), the gaze speed stabilizes. Pupil characteristics may similarly be indicative of user-to-object contact. As illustrated in FIG. 6, during a time period 610 leading up to a user-to-object contact (at time 0), the pupil radius increases.

The method 500 may involve tracking a position of the user relative to an object using an image of the user and the object and determining an occurrence of the user-to-object contact based on the tracking and the determining of the user-to-object contact. FIG. 6 illustrates finger speed during the time period 610, which can be used to determine that a touch has or will occur. The combination of sensor data from image sensors of the user/object, the user's eyes, and the user's body can be combined (e.g., via a sensor fusion technique) to determine that a user-to-object contact will occur, will occur at a particular time, will occur within a particular time window, has occurred, occurred at a particular time, or occurred within a particular time window.

In some implementations, a user characteristic determined from physiological data is used to distinguish between user-to-object contact and the user hovering (e.g., relatively closely) over/near an object. Distinguishing between contact and hovering may lack precision when based upon light intensity and/or depth image data of the user and object, especially in circumstances in which the user/object are far from the sensor or the light intensity and/or depth image data is noisy. Physiological data may be used to distinguish between contacts and hover user interactions and/or to increase the confidence that a touch has occurred or will occur. In some implementations, physiological data may be used to distinguish amongst types of contact and/or to detect different aspects of contact, e.g., touch down and touch up aspects of a contact.

Returning to FIG. 5, in some implementations, given physiological data for a period of time, e.g., a 300 ms time window, the method 500 determines whether the time segment of the physiological data is immediately before a touch event or not, e.g., given data for a time segment from time −300 ms to time 0, whether there will be a touch event at time 0.

FIG. 7 illustrates two exemplary time segments that may be analyzed to make user-to-object contact determinations. In this example, the first time period 710 (i.e., −600 ms to −300 ms) and the second time period 720 (i.e., −300 ms to 0) may be used to classify whether a touch event will or will not occur at time 730. In some implementations, the method 500 repeatedly assesses incoming (e.g., recently obtained) physiological data in incremental time windows (e.g., 300 ms blocks) to determine that a user-to-object contact will occur, will occur at a particular time, will occur within a particular time window, has occurred, occurred at a particular time, or occurred within a particular time window.

One or more muscle characteristics may be indicative of a user-to-object contact. For example, during a time period leading up to a user-to-object contact, the muscles around the wrist of the user as detected by a watch-based sensor may exhibit a particular pattern or time-based characteristic that can be used to determine a user-to-object contact. FIG. 8, in another example, illustrates the positioning of exemplary positioning of electrode pairs on a user's wrist to detect the user's muscles exhibiting one or more patterns or time-based characteristics that can be used to determine user-to-object contact.

Returning to FIG. 5, in some implementations, given physiological data for the period of time, the method 500 predicts whether there will be a touch event within a future time period or not. For example, given data for a time segment from time −300 ms to time 0, the method 500 may determine whether there will be a touch event between time 0 and time 300 ms.

In some implementations, given physiological data for a period of time, e.g., a 300 ms time window, the method 500 predicts when a touch event will occur. In some implementations, user-to-object contact is determined using a classifier implemented via a machine learning model or computer-executed algorithm.

Some implementations disclosed herein determine a user-to-object contact using physiological data to identify a user characteristic that is indicative of user-to-object contact. In some implementations, a machine learning model is trained to make such a determination using a training data from multiple users. Ground truth data can be determined by manually labelling aspects of touch events or by using secondary techniques, e.g., using touch devices as the objects to provide precise contact detection that can be compared with predicted user-to-object contacts. In some implementation, a machine learning model is trained or refined using user-specific data. For example, a user may be instructed to perform a sequence of tasks during which the user makes contact with a touch screen of a device to provide precise contact detection that can be compared with predicted user-to-object contacts.

In some implementations, a machine learning model is trained to use/fuse multiple types of input (e.g., images of the user/objects, physiological data, sound data, and/or user specific data) to predict or otherwise determine aspects of a user-to-object contact. In some implementations, the machine learning model is a neural network (e.g., an artificial neural network), decision tree, support vector machine, Bayesian network, or the like.

In some implementations, the user-to-object is a contact between a user and a physical object of a physical environment. In some implementations the user-to-object contact is a virtual contact between a user and a virtual (e.g., a computer-generated) object. For example, such a virtual contact may occur when a user's finger occupies the same (or is in a 3D position directly adjacent to) the 3D position of a virtual. In some implementations, a virtual object is positioned to overlay a physical object, e.g., a virtual touch screen positioned, on a wall or desk, etc. In some implementations, a virtual object is positioned at a position corresponding to empty space in which the user is located.

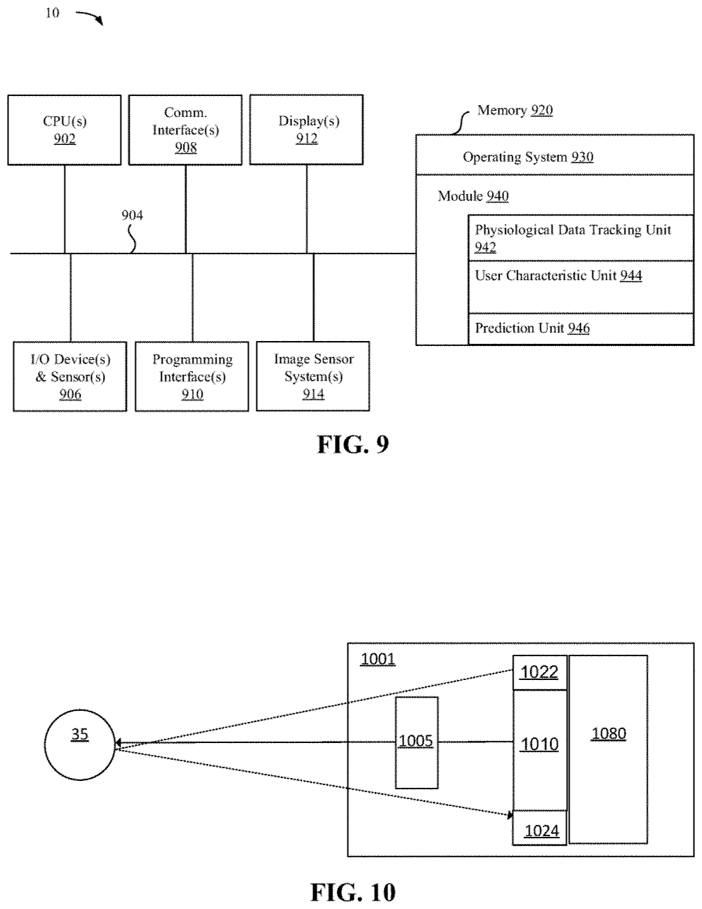

FIG. 9 is a block diagram of an example of a device 10 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more displays 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, electroencephalography (EEG) sensor, electrocardiography (ECG) sensor, electromyography (EMG) sensor, functional near infrared spectroscopy signal (fNIRS) sensor, skin conductance sensor, or image sensor, e.g., for pupillary response, etc.), one or more microphones, one or more speakers, a haptics engine, one or more depth sensors (e.g., a structured light, a time-of-flight, or the like), and/or the like.

In some implementations, the one or more displays 912 are configured to present a user experience to the user 25. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), microelectromechanical system (MEMS), a retinal projection system, and/or the like display types. In some implementations, the one or more displays 912 correspond to diffractive, reflective, polarized, holographic, etc. waveguide displays. In one example, the device 10 includes a single display. In another example, the device 10 includes a display for each eye of the user 25, e.g., an HMD. In some implementations, the one or more displays 912 are capable of presenting extended reality (XR) content, e.g., augmented reality content, virtual reality content, etc.

In some implementations, the one or more image sensor systems 914 are configured to obtain image data that corresponds to at least a portion of the face of the user 25 that includes the eyes of the user 25. For example, the one or more image sensor systems 914 include one or more RGB camera (e.g., with a complimentary metal-oxide-semiconductor (CMOS) image sensor or a charge-coupled device (CCD) image sensor), monochrome camera, IR camera, event-based camera, and/or the like. In various implementations, the one or more image sensor systems 914 further include illumination sources that emit light upon the portion of the face of the user 25, such as a flash or a glint source.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium. In some implementations, the memory 920 or the non-transitory computer readable storage medium of the memory 920 stores the following programs, modules and data structures, or a subset thereof including an optional operating system 920 and a user experience module 940.

The operating system 930 includes procedures for handling various basic system services and for performing hardware dependent tasks. In some implementations, the module 940 is configured to predict or otherwise determine aspects of a user-to-object contact using physiological data. To that end, in various implementations, the module 940 includes a physiological data tracking unit 942, a user characteristic unit 944, and a prediction unit 946.

In some implementations, the physiological data tracking unit 942 is configured to track a user's pupil, muscles, or other physiological attributes using one or more of the techniques discussed herein or as otherwise may be appropriate. To these ends, in various implementations, the unit includes instructions and/or logic therefor, and heuristics and metadata therefor.

In some implementations, the user characteristic unit 944 is configured to determine a user characteristic (e.g., eye or muscle characteristic) using one or more of the techniques discussed herein or as otherwise may be appropriate. To these ends, in various implementations, the unit includes instructions and/or logic therefor, and heuristics and metadata therefor.

In some implementations, the prediction unit 946 is configured to predict or otherwise determine aspects of a user-to-object contact using one or more of the techniques discussed herein or as otherwise may be appropriate. To these ends, in various implementations, the unit includes instructions and/or logic therefor, and heuristics and metadata therefor.

Although the units and modules of FIG. 9 are shown as residing on a single device (e.g., the device 10), it should be understood that in other implementations, any combination of these units may be located in separate computing devices.

Moreover, FIG. 9 is intended more as functional description of the various features which are present in a particular implementation as opposed to a structural schematic of the implementations described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 10 illustrates a block diagram of an exemplary head-mounted device 1000 in accordance with some implementations. The head-mounted device 1000 includes a housing 1001 (or enclosure) that houses various components of the head-mounted device 1000. The housing 1001 includes (or is coupled to) an eye pad (not shown) disposed at a proximal (to the user 25) end of the housing 1001. In various implementations, the eye pad is a plastic or rubber piece that comfortably and snugly keeps the head-mounted device 1000 in the proper position on the face of the user 25 (e.g., surrounding the eye of the user 25).

The housing 1001 houses a display 1010 that displays an image, emitting light towards or onto the eye of a user 25. In various implementations, the display 1010 emits the light through an eyepiece having one or more lenses 1005 that refracts the light emitted by the display 1010, making the display appear to the user 25 to be at a virtual distance farther than the actual distance from the eye to the display 1010. For the user 25 to be able to focus on the display 1010, in various implementations, the virtual distance is at least greater than a minimum focal distance of the eye (e.g., 7 cm). Further, in order to provide a better user experience, in various implementations, the virtual distance is greater than 1 meter.

The housing 1001 also houses a tracking system including one or more light sources 1022, camera 1024, and a controller 1080. The one or more light sources 1022 emit light onto the eye of the user 25 that reflects as a light pattern (e.g., a circle of glints) that can be detected by the camera 1024. Based on the light pattern, the controller 1080 can determine an eye tracking characteristic of the user 25. For example, the controller 1080 can determine a gaze direction and/or a blinking state (eyes open or eyes closed) of the user 25. As another example, the controller 1080 can determine a pupil center, a pupil size, or a point of regard. Thus, in various implementations, the light is emitted by the one or more light sources 1022, reflects off the eye of the user 25, and is detected by the camera 1024. In various implementations, the light from the eye of the user 25 is reflected off a hot mirror or passed through an eyepiece before reaching the camera 1024.

The display 1010 emits light in a first wavelength range and the one or more light sources 1022 emit light in a second wavelength range. Similarly, the camera 1024 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 1010 by looking at it), provide foveated rendering (e.g., present a higher resolution in an area of the display 1010 the user 25 is looking at and a lower resolution elsewhere on the display 1010), or correct distortions (e.g., for images to be provided on the display 1010).

In various implementations, the one or more light sources 1022 emit light towards the eye of the user 25 which reflects in the form of a plurality of glints.

In various implementations, the camera 1024 is a frame/shutter-based camera that, at a particular point in time or multiple points in time at a frame rate, generates an image of the eye of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Some implementations provide a method that comprises, at an electronic device comprising a processor: obtaining, via a sensor, physiological data of a user during a period of time while the user is using the electronic device; determining a characteristic of an eye of the user during the period of time, wherein the characteristic is determined based on the physiological data; and determining a user-to-object contact based on the characteristic of the eye of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the physiological data comprises images of the eye, and the characteristic comprises a gaze direction, a gaze speed, or a pupil radius. In some implementations, the physiological data comprises electrooculography (EOG) data, and the characteristic comprises a gaze direction or a gaze speed. In some implementations, the method further comprises: tracking a position of the user relative to an object using an image of the user and the object; and determining an occurrence of the user-to-object contact based on the tracking and the determining of the user-to-object contact. In some implementations, the device is a head-mounted device (HMD).

Some implementations provide a device comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations. The operations comprise obtaining, via a sensor, physiological data of a user during a period of time while the user is using the electronic device; determining a characteristic of an eye of the user during the period of time, wherein the characteristic is determined based on the physiological data; and determining a user-to-object contact based on the characteristic of the eye of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the physiological data comprises images of the eye, and the characteristic comprises a gaze direction, a gaze speed, or a pupil radius. In some implementations, the physiological data comprises electrooculography (EOG) data, and the characteristic comprises a gaze direction or a gaze speed. In some implementations, the operations further comprise: tracking a position of the user relative to an object using an image of the user and the object; and determining an occurrence of the user-to-object contact based on the tracking and the determining of the user-to-object contact. In some implementations, the device is a head-mounted device (HMD).

Some implementations provide a non-transitory computer-readable storage medium, storing computer-executable program instructions on a computer to perform operations comprising: obtaining, via a sensor, physiological data of a user during a period of time while the user is using the electronic device; determining a characteristic of an eye of the user during the period of time, wherein the characteristic is determined based on the physiological data; and determining a user-to-object contact based on the characteristic of the eye of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the physiological data comprises images of the eye, and the characteristic comprises a gaze direction, a gaze speed, or a pupil radius. In some implementations, the physiological data comprises electrooculography (EOG) data, and the characteristic comprises a gaze direction or a gaze speed. In some implementations, the operations further comprise: tracking a position of the user relative to an object using an image of the user and the object; and determining an occurrence of the user-to-object contact based on the tracking and the determining of the user-to-object contact. In some implementations, the device is a head-mounted device (HMD).

Some implementations provide a method that comprises, at an electronic device comprising a processor: obtaining, via a sensor, physiological data of a user during a period of time while the user is using the electronic device; determining a characteristic of a muscle of the user during the period of time, wherein the characteristic is determined based on the physiological data, wherein the physiological data comprises electromyography (EMG) data; and determining a user-to-object contact based on the characteristic of the muscle of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the method comprises tracking a position of the user relative to an object using an image of the user and the object; and determining an occurrence of the user-to-object contact based on the tracking and the determining of the user-to-object contact. In some implementations, the device is a head-mounted device (HMD).

Some implementations provide a device comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations. The operations comprise obtaining, via a sensor, physiological data of a user during a period of time while the user is using the electronic device; determining a characteristic of a muscle of the user during the period of time, wherein the characteristic is determined based on the physiological data, wherein the physiological data comprises electromyography (EMG) data; and determining a user-to-object contact based on the characteristic of the muscle of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the operations comprise tracking a position of the user relative to an object using an image of the user and the object; and determining an occurrence of the user-to-object contact based on the tracking and the determining of the user-to-object contact. In some implementations, the device is a head-mounted device (HMD).

Some implementations provide a non-transitory computer-readable storage medium, storing computer-executable program instructions on a computer to perform operations comprising: obtaining, via a sensor, physiological data of a user during a period of time while the user is using the electronic device; determining a characteristic of a muscle of the user during the period of time, wherein the characteristic is determined based on the physiological data, wherein the physiological data comprises electromyography (EMG) data; and determining a user-to-object contact based on the characteristic of the muscle of the user during the period of time. In some implementations, user-to-object contact is determined using a classifier implemented via a machine learning model or computer-executed algorithm. In some implementations, determining the user-to-object contact comprises predicting whether the period of time is immediately prior to the user-to-object contact. In some implementations, determining the user-to-object contact comprises predicting whether the user-to-object contact will occur within a second period of time following the period of time. In some implementations, determining the user-to-object contact comprises predicting a time at which the user-to-object contact will occur. In some implementations, the operations comprise tracking a position of the user relative to an object using an image of the user and the object; and determining an occurrence of the user-to-object contact based on the tracking and the determining of the user-to-object contact. In some implementations, the device is a head-mounted device (HMD).

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device comprising a processor:
obtaining, via a sensor, physiological data of a user during a period of time while the user is using the electronic device;
determining a characteristic of an eye of the user during the period of time, wherein the characteristic is determined based on the physiological data; and
determining a user-to-object contact based on the characteristic of the eye of the user during the period of time.

2. The method of claim 1, wherein user-to-object contact is determined using a classifier implemented via a machine learning model or computer-executed algorithm.

3. The method of claim 1, wherein determining the user-to-object contact comprises predicting whether the period of time is immediately prior to the user-to-object contact.

4. The method of claim 1, wherein determining the user-to-object contact comprises predicting whether the user-to-object contact will occur within a second period of time following the period of time.

5. The method of claim 1, wherein determining the user-to-object contact comprises predicting a time at which the user-to-object contact will occur.

6. The method of claim 1, wherein the physiological data comprises images of the eye, and the characteristic comprises a gaze direction, a gaze speed, or a pupil radius.

7. The method of claim 1, wherein the physiological data comprises electrooculography (EOG) data, and the characteristic comprises a gaze direction or a gaze speed.

8. The method of claim 1 further comprising:
tracking a position of the user relative to an object using an image of the user and the object; and
determining an occurrence of the user-to-object contact based on the tracking and the determining of the user-to-object contact.

9. The method of claim 1, wherein the device is a head-mounted device (HMD).

10. A method comprising:
at an electronic device comprising a processor:
obtaining, via a sensor, physiological data of a user during a period of time while the user is using the electronic device;
determining a characteristic of a muscle of the user during the period of time, wherein the characteristic is determined based on the physiological data, wherein the physiological data comprises electromyography (EMG) data; and
determining a user-to-object contact based on the characteristic of the muscle of the user during the period of time.

11. The method of claim 10, wherein user-to-object contact is determined using a classifier implemented via a machine learning model or computer-executed algorithm.

12. The method of claim 10, wherein determining the user-to-object contact comprises predicting whether the period of time is immediately prior to the user-to-object contact.

13. The method of claim 10, wherein determining the user-to-object contact comprises predicting whether the user-to-object contact will occur within a second period of time following the period of time.

14. The method of claim 10, wherein determining the user-to-object contact comprises predicting a time at which the user-to-object contact will occur.

15. The method of claim 10 further comprising:
tracking a position of the user relative to an object using an image of the user and the object; and
determining an occurrence of the user-to-object contact based on the tracking and the determining of the user-to-object contact.

16. The method of claim 10, wherein the device is a head-mounted device (HMD).

17. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining, via a sensor, physiological data of a user during a period of time while the user is using the electronic device;
determining a characteristic of an eye of the user during the period of time, wherein the characteristic is determined based on the physiological data; and
determining a user-to-object contact based on the characteristic of the eye of the user during the period of time.

18. The device of claim 17, wherein user-to-object contact is determined using a classifier implemented via a machine learning model or computer-executed algorithm.

19. The device of claim 17, wherein determining the user-to-object contact comprises predicting whether the period of time is immediately prior to the user-to-object contact.

20. The device of claim 17, wherein determining the user-to-object contact comprises predicting whether the user-to-object contact will occur within a second period of time following the period of time.
